(19) United States
(12) Patent Application Publication
(10) Pub. No.: US 2025/0086509 A1
(43) Pub. Date: Mar. 13, 2025

(54) USING CORRELATION BETWEEN OBSERVED VERSUS EXPECTED BEHAVIOR FOR OBJECT MODEL RELATIONSHIP TRACKING

(71) Applicant: OptumSoft, Inc., Vero Beach, FL (US)

(72) Inventor: David R. Cheriton, Vero Beach, FL (US)

(21) Appl. No.: 18/829,048

(22) Filed: Sep. 9, 2024

Related U.S. Application Data
(60) Provisional application No. 63/537,721, filed on Sep. 11, 2023.

(51) Int. Cl. G06N 20/00

(52) U.S. Cl. CPC G06N 20/00

(57) ABSTRACT

A model comprising a plurality of objects and expected behaviors of the plurality of objects is accessed. Observed behaviors of one or more objects in the model are received, the observed behaviors being obtained by a sensor configured to collect observed behaviors. One or more relationships between at least two of the objects in the model are determined, at least in part by use of a matching mechanism based at least on one or more observed behaviors and one or more expected behaviors. The one or more relationships are output to an actuator configured to take suitable application action.

### CROSS REFERENCE TO OTHER APPLICATIONS

This application claims priority to U.S. Provisional Patent Application No. 63/537,721 entitled USING CORRELATION BETWEEN OBSERVED VERSUS EXPECTED BEHAVIOR FOR OBJECT MODEL RELATIONSHIP TRACKING filed Sep. 11, 2023 which is incorporated herein by reference for all purposes.

### BACKGROUND OF THE INVENTION

Many applications for monitoring and control require the implementing computer system to maintain a model of the deployed system being monitored and/or controlled. For example, an application monitoring a deployed computer network for faults may use a computer system to maintain a model of the network. The deployed system is dynamically changing, for example in the application monitoring the deployed computer network example, by adding or removing switches or changing the links between them as well as the various elements performing actions, such as forward packets. The application model needs to track the changing state of the deployed system to properly monitor and control it.

### BRIEF DESCRIPTION OF THE DRA WINGS

Various embodiments of the invention are disclosed in the following detailed description and the accompanying drawings.

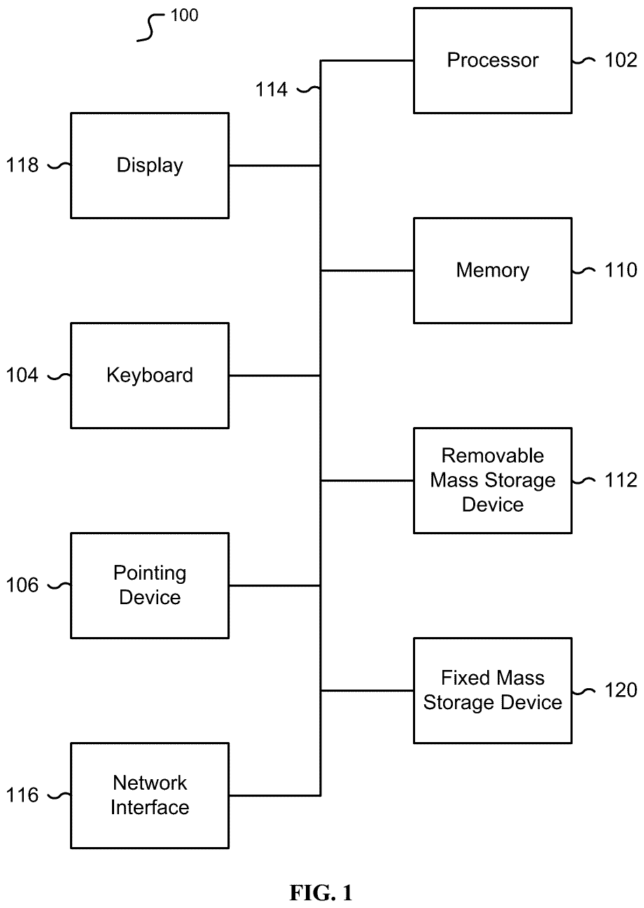

FIG. 1 is a functional diagram illustrating a programmed computer/server system for relationship tracking in accordance with some embodiments.

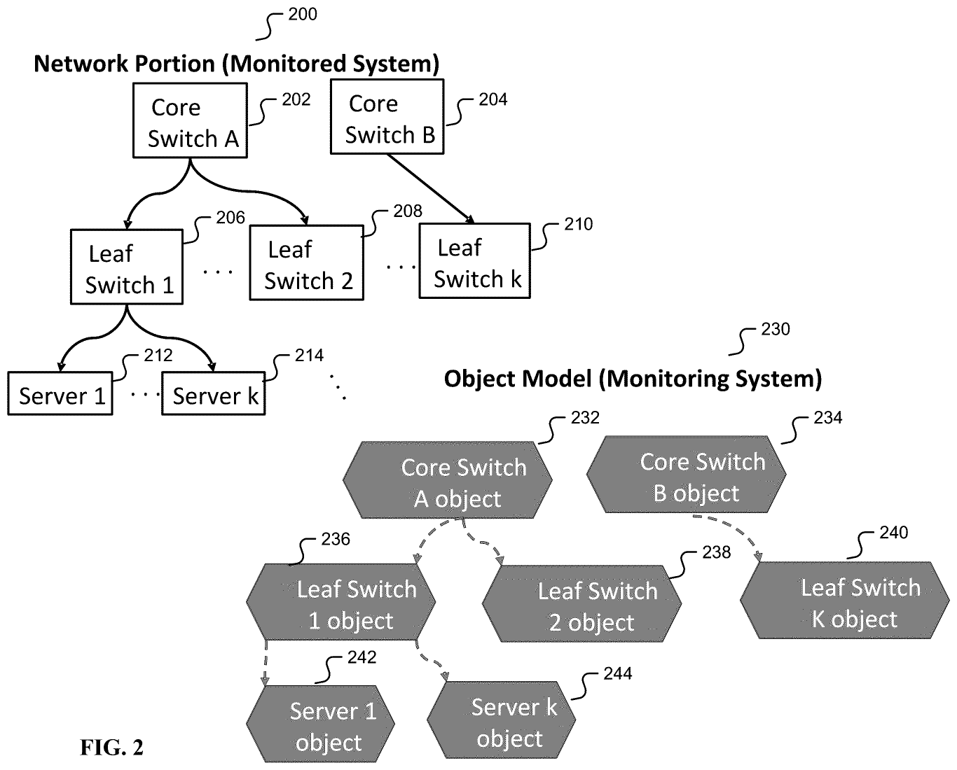

FIG. 2 is a diagram illustrating an example of a network with a portion of a network and its object model.

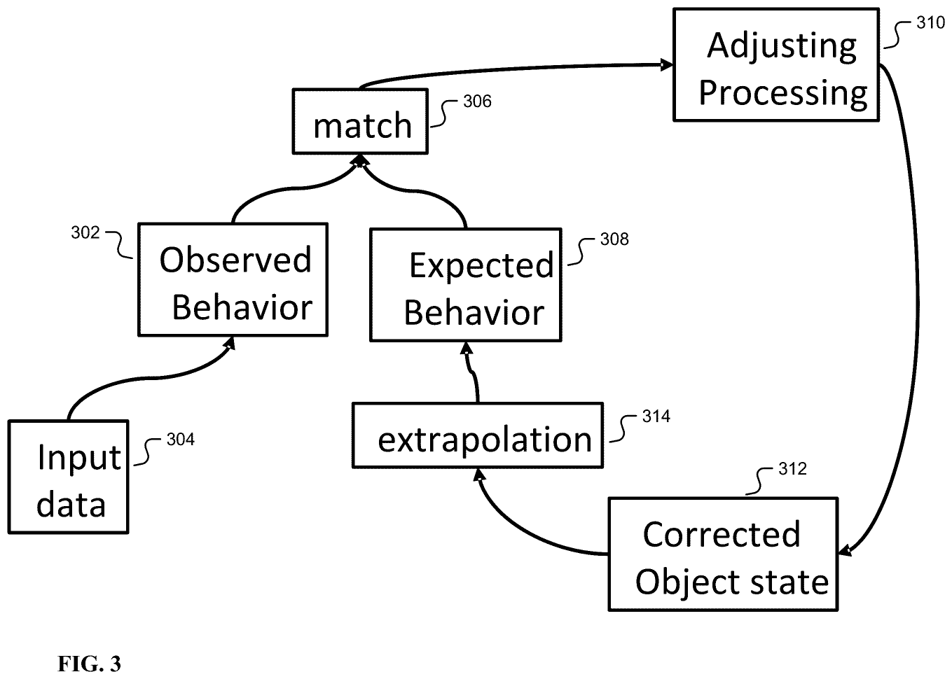

FIG. 3 is a diagram illustrating an example of a feedback loop for dynamic tracking of a deployed system.

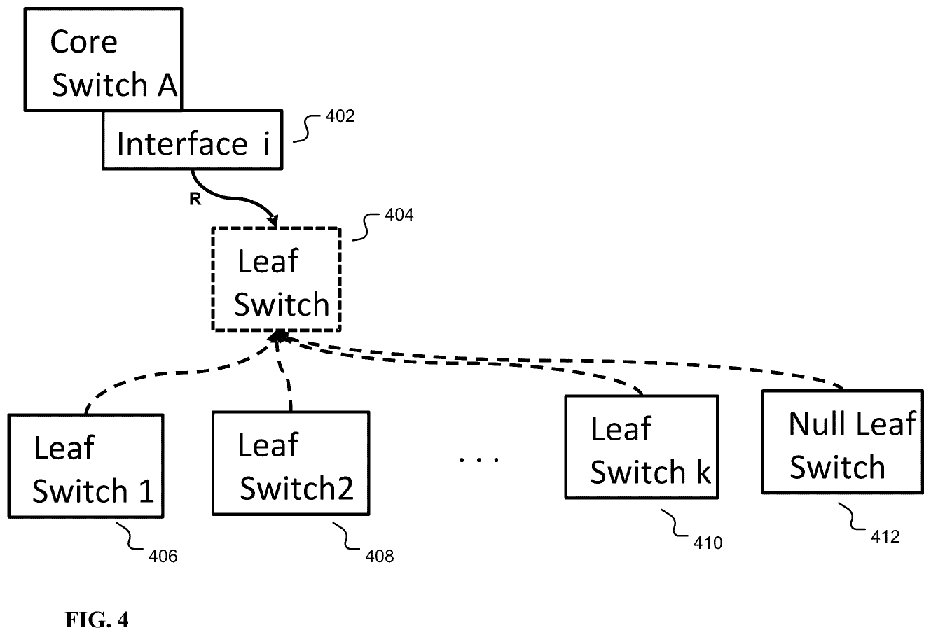

FIG. 4 is a diagram illustrating an example of an anchored relationship entity resolution.

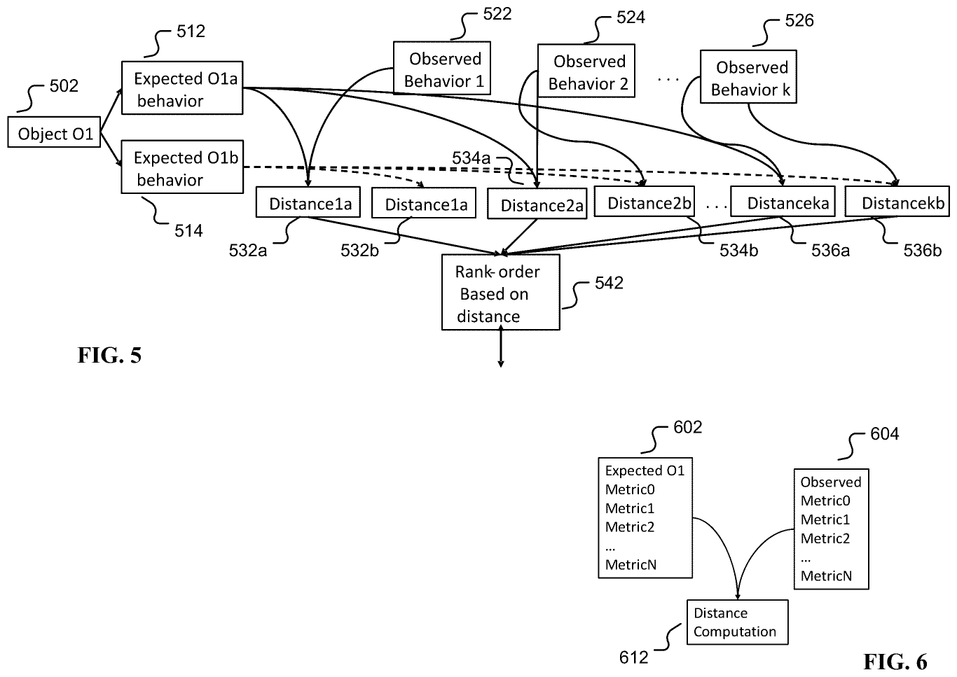

FIG. 5 is a diagram illustrating an example of a logical correlation between expected behavior and various observed behaviors based on distance measure.

FIG. 6 is a diagram illustrating an example of computing the distance/logical correlation between the expected and the observed behavior based on metrics in the two behaviors.

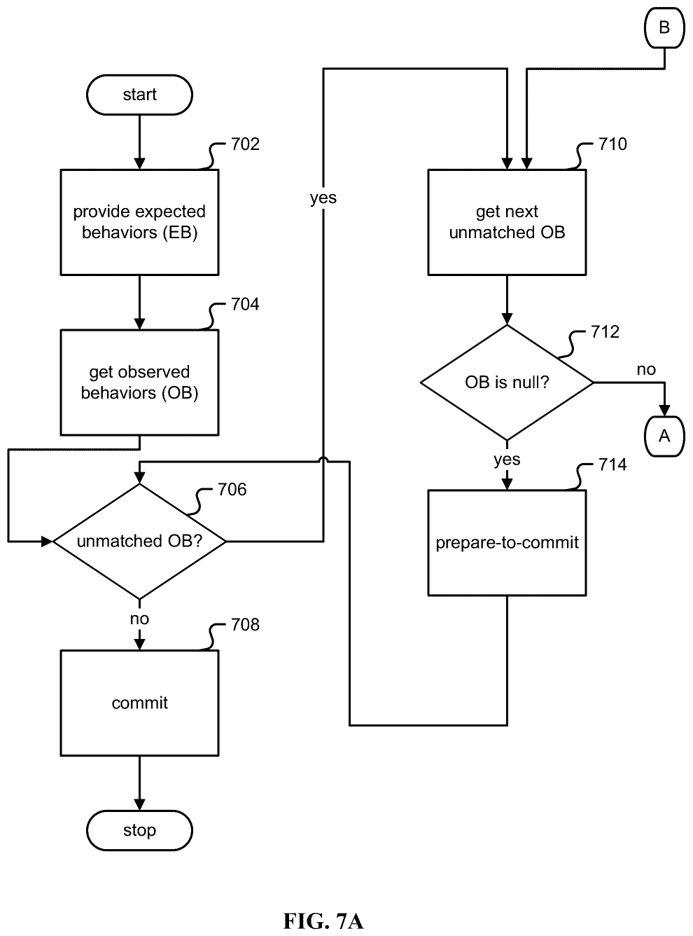

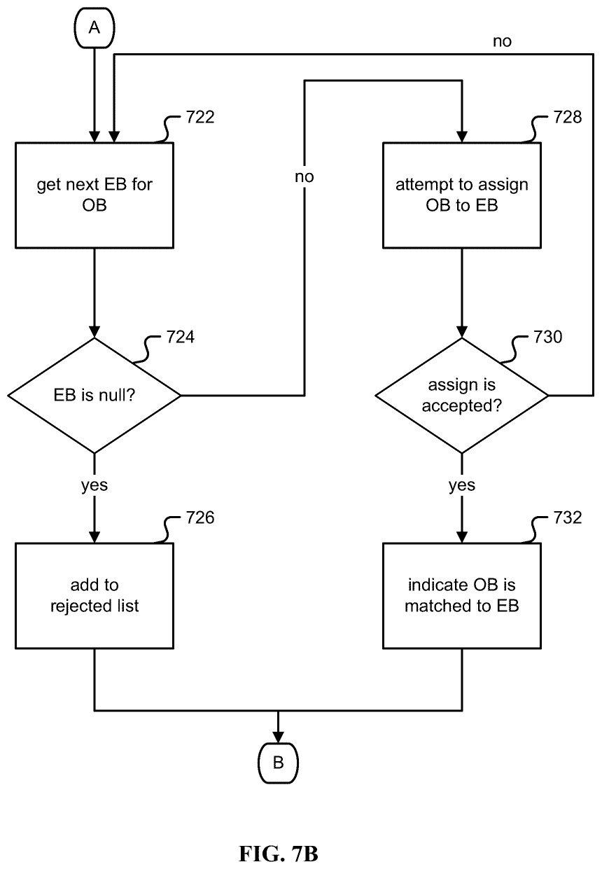

FIGS. 7A and 7B are a flow diagram illustrating an embodiment of a process for matching of observed behavior to expected behavior.

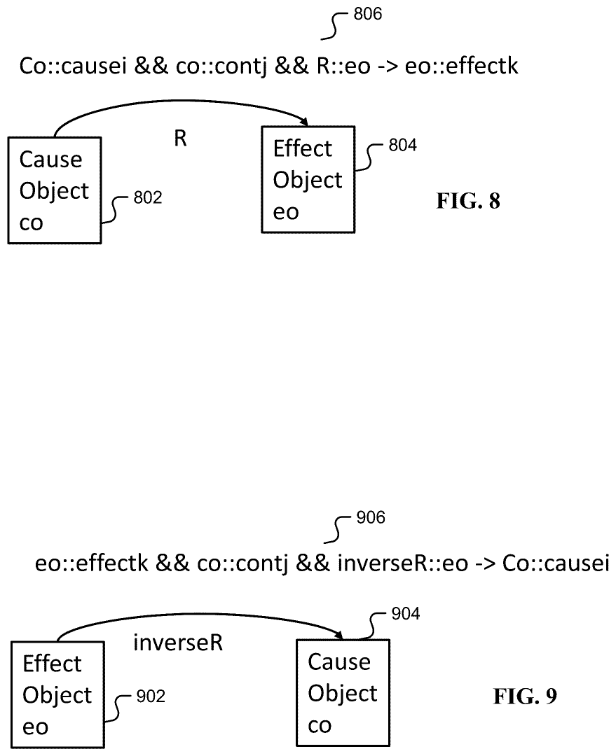

FIG. 8 is a diagram illustrating an example of predicting expected behavior based on cause-effect rules.

FIG. 9 is a diagram illustrating an example of predicting expected behavior based on inverse rules to cause-effect rules.

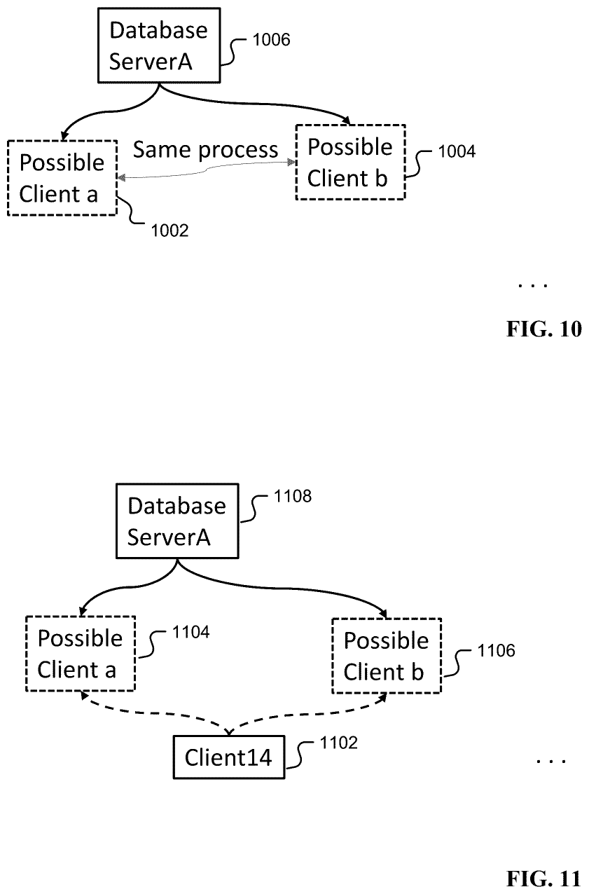

FIG. 10 is a diagram illustrating an example of entity resolution by an inter-object relationship or linking.

FIG. 11 is a diagram illustrating an example of entity resolution by relationship to a master object.

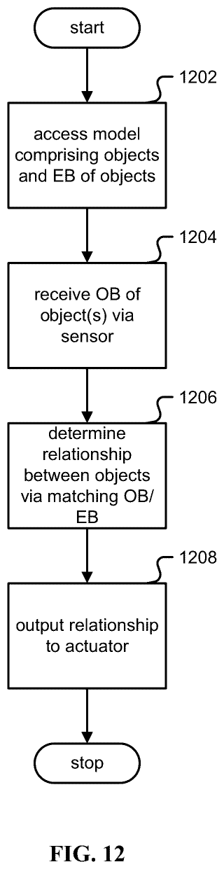

FIG. 12 is a flow diagram illustrating an embodiment of a process for using correlation between observed versus expected behavior for object model relationship tracking.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As described above, an application for monitoring and control requires a computer system to maintain a model of the deployed system being monitored and/or controlled. The application model needs to track the changing state of the deployed system to properly monitor and control it. This application model is realized as and referred to herein as an object model. For instance, in the network example, the network is modelled as a collection of objects representing the switches in the network and the links between them. There may also be a separate management network, where the switches are connected by a link, directly or indirectly to a monitoring station. In the object model, as referred to herein an object is a collection of data structures and procedures in the computer memory that represent the aggregation of state and behavior that, in this case, corresponds to a real object such as a switch, link, interface, and so on in the monitored/controlled system. Using correlation between observed versus expected behavior for object model relationship tracking is disclosed.

Determining relationships between objects based at least in part on matching object behaviors is disclosed. By matching object behaviors, matching mechanisms like that used in the stable matching problem in computing such as stable marriage, college acceptance, and/or hospital residency may be leveraged to determine the relationships between objects with adjustment, for example by deferring rejection in the stable matching problem. Thus with an adjusted matching mechanism a pool of expected behaviors may be best matched, even if imperfect, to a pool of observed behaviors. Put another way, the system matches on behaviors not on the entities/objects, and the matching on the behaviors allows inferring which entities/objects are which.

FIG. 1 is a functional diagram illustrating a programmed computer/server system for relationship tracking in accordance with some embodiments. As shown, FIG. 1 provides a functional diagram of a general-purpose computer system programmed to provide relationship tracking in accordance with some embodiments. As will be apparent, other computer system architectures and configurations can be used for relationship tracking.

Computer system 100, which includes various subsystems as described below, includes at least one microprocessor subsystem, also referred to as a processor or a central processing unit (“CPU”) 102. For example, processor 102 can be implemented by a single-chip processor or by multiple cores and/or processors. In some embodiments, processor 102 is a general purpose digital processor that controls the operation of the computer system 100. Using instructions retrieved from memory 110, the processor 102 controls the reception and manipulation of input data, and the output and display of data on output devices, for example display and graphics processing unit (GPU) 118.

Processor 102 is coupled bi-directionally with memory 110, which can include a first primary storage, typically a random-access memory (“RAM”), and a second primary storage area, typically a read-only memory (“ROM”). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 102. Also as well known in the art, primary storage typically includes basic operating instructions, program code, data, and objects used by the processor 102 to perform its functions, for example, programmed instructions. For example, primary storage devices 110 can include any suitable computer-readable storage media, described below, depending on whether, for example, data access needs to be bi-directional or uni-directional. For example, processor 102 can also directly and very rapidly retrieve and store frequently needed data in a cache memory, not shown. The processor 102 may also include a coprocessor (not shown) as a supplemental processing component to aid the processor and/or memory 110.

A removable mass storage device 112 provides additional data storage capacity for the computer system 100, and is coupled either bi-directionally (read/write) or uni-directionally (read-only) to processor 102. For example, storage 112 can also include computer-readable media such as flash memory, portable mass storage devices, holographic storage devices, magnetic devices, magneto-optical devices, optical devices, and other storage devices. A fixed mass storage 120 can also, for example, provide additional data storage capacity. One example of mass storage 120 is an eMMC or microSD device. In one embodiment, mass storage 120 is a solid-state drive connected by a bus 114. Mass storages 112, 120 generally store additional programming instructions, data, and the like that typically are not in active use by the processor 102. It will be appreciated that the information retained within mass storages 112, 120 can be incorporated, if needed, in standard fashion as part of primary storage 110, for example RAM, as virtual memory.

In addition to providing processor 102 access to storage subsystems, bus 114 can be used to provide access to other subsystems and devices as well. As shown, these can include a display monitor 118, a communication interface 116, a touch (or physical) keyboard 104, and one or more auxiliary input/output devices 106 including an audio interface, a sound card, microphone, audio port, audio input device, audio card, speakers, a touch (or pointing) device, and/or other subsystems as needed. Besides a touch screen, the auxiliary device 106 can be a mouse, stylus, track ball, or tablet, and is useful for interacting with a graphical user interface.

The communication interface 116 allows processor 102 to be coupled to another computer, computer network, or telecommunications network using a network connection as shown. For example, through the communication interface 116, the processor 102 can receive information, for example data objects or program instructions, from another network, or output information to another network in the course of performing method/process steps. Information, often represented as a sequence of instructions to be executed on a processor, can be received from and outputted to another network. An interface card or similar device and appropriate software implemented by, for example executed/performed on, processor 102 can be used to connect the computer system 100 to an external network and transfer data according to standard protocols. For example, various process embodiments disclosed herein can be executed on processor 102, or can be performed across a network such as the Internet, intranet networks, or local area networks, in conjunction with a remote processor that shares a portion of the processing. Throughout this specification, “network” refers to any interconnection between computer components including the Internet, Bluetooth, WiFi, 3G, 4G, 4GLTE, 5G, GSM, Ethernet, intranet, local-area network (“LAN”), home-area network (“HAN”), serial connection, parallel connection, wide-area network (“WAN”), Fibre Channel, PCI/PCI-X, AGP, VLbus, PCI Express, Expresscard, Infiniband, ACCESS.bus, Wireless LAN, HomePNA, Optical Fibre, G.hn, infrared network, satellite network, microwave network, cellular network, virtual private network (“VPN”), Universal Serial Bus (“USB”), FireWire, Serial ATA, 1-Wire, UNI/O, or any form of connecting homogenous and/or heterogeneous systems and/or groups of systems together. Additional mass storage devices, not shown, can also be connected to processor 102 through communication interface 116.

An auxiliary I/O device interface, not shown, can be used in conjunction with computer system 100. The auxiliary I/O device interface can include general and customized interfaces that allow the processor 102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: flash media such as NAND flash, eMMC, SD, compact flash; magnetic media such as hard disks, floppy disks, and magnetic tape; optical media such as CD-ROM disks; magneto-optical media such as optical disks; and specially configured hardware devices such as application-specific integrated circuits (“ASIC”s), programmable logic devices (“PLD”s), and ROM and RAM devices. Examples of program code include both machine code, as produced, for example, by a compiler, or files containing higher level code, for example a script, that can be executed using an interpreter.

The computer/server system shown in FIG. 1 is but an example of a computer system suitable for use with the various embodiments disclosed herein. Other computer systems suitable for such use can include additional or fewer subsystems. In addition, bus 114 is illustrative of any interconnection scheme serving to link the subsystems. Other computer architectures having different configurations of subsystems can also be utilized.

FIG. 2 is a diagram illustrating an example of a network with a portion of a network and its object model. FIG. 2 illustrates tracking relationships between objects in an application model versus the corresponding objects in a deployed or monitored system, that is the relationships in the object model track those in the real system. As shown in FIG. 2, in the network portion (200) there are core switches such as core switch A (202) and core switch B (204), leaf switches such as leaf switch 1 (206), leaf switch 2 (208), and leaf switch k (210), and servers such as server 1 (212) and server k (214). In the associated object model (230) there are corresponding core switch objects such as a core switch A object (232) and core switch B object (234), corresponding leaf switch objects such as leaf switch 1 object (236), leaf switch 2 object (238), and leaf switch k object (240), and corresponding server objects such as server 1 object (242) and server k object (244). That is, core switch A (202) is represented in the associated object model by core switch A object (232), and so on.

A detailed model may break down a top-level object such as a switch object into multiple component objects. For example, a switch is composed of a power supply, supervisor card and multiple switch interface cards. This component-level modelling is often required to adequately, that is with sufficient accuracy, model the behavior of the system being monitored and/or controlled. For example, the per-interface transmit and receive counters are best understood as being part of a switch interface so the model may handle multiple, that is per-interface, sets of these counters and associate such counters with the corresponding link or connection. Therefore, a switch is modelled as having multiple component interfaces.

The use of a model implies that the deployed system has a restricted set of object types. For instance, the types of objects that may occur in a computer network may be restricted to switches and servers. The model does not, and normally cannot, handle a random new type of object appearing without careful modification to the application model implementation.

An object model represents inter-object relationships, not just the individual object state. The connections between the switches correspond to relationships between these objects, and are referred to herein as bi-directional relationships because the switch at one end is connected to the one at the other end, and vice versa. The management network may specify or imply a bi-directional relationship, for example a manager/managee relationship. Each object plays what is referred to herein as a role in one or more relationships, for example manager or managee.

A physical connection may not be the only way to establish relationships between objects. For instance, an application process and a database process may be connected by an application-layer connection, even if not directly connected. Also, in a cluster of robots, two robots within a certain proximity may be in a cooperative or alternatively, conflicting, relationship. Even “existence” and identity may be regarded as a relationship to some parent object. For example, for identity, there may be some parent or directory mechanism that ensures uniqueness, that is that some value, its name or identity number, identifies and maps to the identified element. Conversely, two different entities may have the same identification with two different parents or directory systems.

Relationships between objects may be used to perform root cause identification of a fault as well as impact analysis. These relationships may also be used to determine control actions when controlling the deployed system.

In some applications, relationships between deployed elements may change dynamically without informing the computer system maintaining the model. For example, a technician may unplug a cable from one interface and plug it into a different interface without updating the object model. Furthermore, the connection between switch interfaces may be through an optical switch that may change the effective connection in milliseconds without human involvement.

In some applications, a requirement is to discover relationships after they are established and/or changed. For instance, in a forensic investigation, the model is that there is a perpetrator, co-conspirators or facilitators, bystanders and victims. There may be a need to determine the relationship between the evidence as observed behavior and the objects in this model.

If one or more relationships in the model are incorrect, the object model is not tracking the deployed system accurately and functions that depend on this model, such as root cause identification or forensic investigation, may produce false positives or false negatives, so may not be reliable. Similarly, if used for control, the control system may take incorrect control actions.

Detecting and/or resolving changes to relationships between the elements that an object model is tracking, and then either automatically correcting or else raising an alert is disclosed. This is referred to herein as object model relationship tracking. Using object model relationship tracking improves computing resource utilization, including more efficient processing, lower memory/storage usage, lower network usage, and/or reduced run-time/development time.

Network Example. Put another way, with all relationships between objects, the problem to address is how to maintain this object model (230) to be consistent with the actual system (200), for example the network as shown in FIG. 1. For example, at one timestep the network (200) is analyzed and an object model (230) is programmed accordingly. At a subsequent timestep, a technician changes things such that server k (214) is connected to leaf switch 2 (208) instead of leaf switch 1 (206), making the object model (230) incorrect. Thus the net analysis at the next timestep tracks/detects this and programs a subsequent object model (230) with correct relationships. An example range of a timestep interval may be between 50 to 100 milliseconds.

An improvement of model tracking is getting information about the behavior of the system modeled. For example, a network monitored for failures may include receiving input data comprising how much data is flowing through a core switch, a leaf switch, and how much activity is detected on servers so it may be detected when an element has failed or an element has overloaded. These are examples of observed behavior. A problem to be modelled is detecting problems in the monitored system wherein there is also expected behavior where a certain amount of traffic occurs between connected switches and so on. Comparing expected behavior and observed behavior to determine a match is disclosed. This comprises correcting the expected object state based on what is being observed as long as it is reasonably consistent with the expected behavior.

For example, if there is an expected behavior that there is a lot of load on a given switch between the hours at 09:00 and 17:00, this includes an expectation of the amount of traffic expected when collecting this data from the switch, indicating how much traffic is actually going through there. This expectation may be adjusted to address amounts of data that are “close” to expected but just a little different. By contrast, if the amount is significantly different, that may be indicative of a problem in the monitored system. Furthermore, once a significant deviation is detected, this may adjust a subsequent timestep's expectation to correct that state, for example if the switch is typically loaded at a specific amount 60% at noon, then the next day the expectation may be adjusted to be loaded at that roughly 60%. Thus, learning what to expect via previous observations and then matching those over time to have expectations match fairly closely helps detect when something is going wrong.

Note that expected behaviors when trying to understand whether something is working correctly is dependent on knowing the relationships between objects correctly. Continuing the networking example, if there is an expectation there is a high amount of traffic going out of core switch A (202) into leaf switch 2 (208), then if the leaf switch 2 (208) is not receiving this traffic, an assumption may be there is a problem of a broken link between core switch A (202) and leaf switch 2 (208), or perhaps packets are getting corrupted on that link, or another problem of that nature. This assumption is dependent on knowing that core switch A (232) and switch 2 (238) are connected because behaviors are being correlated between these two objects to answer whether the relationship works properly. So it's important to have the relationships being correct. The focus of attempting to ensure correct relationship may be addressed using entity resolution as described below.

Robot Example. Another example not shown in FIG. 1 is that of a robot in an environment where it attempts to sense things in and understand what is connected to what, like: “Is this doorknob connected to a door?” and “Is this object on the table, is that part of the table, or is that movable?”

Object Model Relationship Tracking. Object model relationship tracking may be achieved by converting this into a problem referred to herein as entity resolution and then performing entity resolution by:
1. inferring the expected behavioral history of an object Oi in a given inter-object relationship or set of relationships relative to certain other objects;
2. comparing the observed behavioral histories of other objects that may potentially be in that relationship or relationships to that expected behavior; and then
3. matching the object Oi with the observed behavioral histories that are most strongly and sufficiently correlated with the expected behavior relative to other possible matches, thereby concluding that Oi is the entity in the associated relationship or relationships associated with those certain objects.

FIG. 3 is a diagram illustrating an example of a feedback loop for dynamic tracking of a deployed system. As shown in FIG. 3, this tracking is by feedback between an observed behavior and an expected behavior, given the matching of entity resolution. For example, FIG. 3 illustrates tracking object relationships based on feedback from matching the observed behavior(s) to the expected behaviors of objects in the system. In one embodiment, matching of observed and expected behavior leads to adjusting, to produce corrected object state which then is extrapolated to produce expected behavior for a next timestep.

As shown in FIG. 3, the observed behavior (302) generated from input data (304) is matched (306) with expected behavior (308), which leads to adjustment processing (310) that adjusts the state of the associated object to produce corrected object state (312), which is then extrapolated (314) to produce the expected behavior for the next timestep. This next step expected behavior is then matched to sensor input provided in the next timestep, repeating the cycle. A significant aspect of object model relationship tracking deals with the matching of expected and observed behaviors when there are typically many objects and thus many expected and observed behaviors. In one embodiment, there are a massive number of objects, for examples dozens, hundreds, or thousands, which may not be done manually but done with automation. In one embodiment, the timesteps are small for example in nanoseconds, microseconds, or milliseconds, which may not be done manually but done with automation.

Object model relationship tracking is converted to a form of entity resolution by viewing that for each object, referred to herein as an anchor object, every possible inter-object relationship for that anchor object exists, wherein some may be to a null object. Therefore, there is as referred to herein an expected object for this inter-object relationship for the given anchor object. Thus, the problem is determining which object, including possibly the null object, corresponds to this expected object in this anchored relationship, that is as in the given relationship relative to a given anchor object or objects. This is referred to herein as anchored relationship entity resolution (ARER). This is because in part the entity in the relationship to the anchor object is what is being resolved.

Anchored Relationship Entity Resolution. FIG. 4 is a diagram illustrating an example of an anchored relationship entity resolution. As shown in FIG. 4, it is determined which leaf switch actually corresponds to that connected to interface i of core switch A, the anchor object. For example, FIG. 4 illustrates how tracking a relationship R may be handled as performing entity resolution on an object in this relationship to a given object. In FIG. 4, a core switch interface i (402), the anchor object (402), is “connectedTo” an interface in some leaf switch (404), with “connectedTo” being the relationship. One question to determine is: Which of the possible leaf switches, namely 1 thru K, (406), (408), (410), is it?

In one embodiment, the expected switch interface has an expected behavior based on this “connectedTo” relationship. Therefore, the particular leaf switch whose interface has the observed behavior that best matches this expected behavior is the best candidate for being in this “connectedTo” relationship with this core switch interface.

Returning to the network switch example, the entity resolution in FIG. 4 addresses the problem of having a core switch A with an interface I (402) connected to some leaf switch, but it is unknown which one it is. The question identifying what is the switch that this is connected to may be alternately posed as “Who is switch (404)?”, rather than “What is in this relationship between Core Switch A and some leaf switch?”

This is similar to the entity relationship problem in databases where there is a transaction such as “John Smith paid $100 for this item” and another entry “J Smith lives at this address”, and the question is: “Is J Smith and John Smith the same person?” Thus, entity resolution is the question of resolving whether these different things all represent the same thing.

Returning to the network switch example, there are potential candidates for being the connected leaf switch (404), and the question is “Which one is it?” If there are case switches in the data center, it may be one of the leaf switch 1 (406), leaf switch 2 (408), . . . leaf switch k (410) or it is not connected to any which is modeled as a null switch (412). So rather than focus on who is in the relationship, it is determined which of these switches is in it, which resolves the entity.

FIG. 5 is a diagram illustrating an example of a logical correlation between expected behavior and various observed behaviors based on distance measure. For example, FIG. 5 illustrates determining the logical correlation between expected behavior and various observed behaviors based on a distance measure between them. As shown in FIG. 5, for an object, for example object O1 (502), the matching between expected object behaviors, for example expected behavior O1a (512) and expected behavior O1b (514), and observed object behaviors, for example observed behavior 1 (522), observed behavior 2 (524), and observed behavior k (526), may use a distance measure to determine which observed behavior is best correlated with multiple expected behaviors as well as multiple observed behavioral histories. For example, distance 1a (532a) may be the distance measure between expected behavior O1a (512) and observed behavior 1 (522), and so on. The distance between each pair of expected and the observed behaviors is computed and the pairs are rank-ordered (542), for example ranking each pairing [expected, observed] based on distance. An error may be reported if there is no pairing between expected and observed for an object that is acceptable. In one embodiment, if an object that should not go away has no observed behavior, it is reported by an indication rather than simply matching to a null object.

In one embodiment, the choice of assignments is evaluated collectively over the entire subset or on an individual assignment basis. For an individual basis, each observed behavior is matched to the expected behavior that has the lowest distance to it. For a collective basis, the match is evaluated across all of the objects being matched. Thus, it may be the case that a given observed behavior is matched to another expected behavior that is not the closest one according to this distance measure. For example, if, in a network, assigning a given switch to be in the “connectedTo” relationship with the anchor switch would be a good match based on distance but would require a change to the current assignments for other switches that would be collectively worse, then this change may not be selected. That is, the choice may require another switch to be removed from this relationship which may require re-assignments of other relationships. When no acceptable choice of assignments can be achieved, there is an indication provided to the application, for example an error report.

Observed Behavior. As referred to herein, observed behavior is that discerned from telemetry coming directly or indirectly from sensors. This telemetry directly or indirectly indicates the object's behavior for a given relation or multiple relations. For example, a given switch interface may be observed to have (that is, reported that it has) received RP packets and RB bytes over the past time interval Ti, and detected a loss of input signal for 1 second at the start of Ti and transmitted TP packets and TB bytes. As part of tracking the state of the system being monitored or controlled, there may be a need to observe the behavior, that is state changes over time, in the monitored system and thus determine this observed behavior.

A sensor as referred to herein includes a device that detects, measures, and/or responds to a property and/or record, for example a physical property and/or physical record. A sensor may be a physical sensor such as a load cell or a virtual sensor such as a a counter implemented in software. Examples of a sensor include without limitation: a camera, pressure sensor, speed sensor, fluid level sensor, load sensor, position sensor, torque sensor, center of gravity sensor, feedback sensor, airspeed sensor, vertical speed sensor, altimeter, cabin pressure sensor, temperature sensor, variable transformer sensors, force sensor, vibration sensor, magnetometer, gyroscope, data monitoring sensor, telemetry sensor, ultrasonic sensor, infrared sensor, speedometer, tachometer, tension sensor, microphone, a mechanical sensor, an electromagnetic sensor, an electronic sensor, a solid state sensor, an optical sensor, a company stock exchange (including a sensor to sense a stock price value), and/or a doctor's equipment such as a blood pressure sensor/oxygen sensor.

In one embodiment, the observed behavior of an object is used to update the recorded state of that object in the object model. For example, the transmit packet count in an object corresponding to a given switch interface may be updated by the observed behavior reported back about the actual deployed switch interface. As another example, the actual dimensions of another robot in a multi-robot environment may be updated to be consistent with the observed behavior, for example that it is appearing in the observed behavior to occupy more space in the environment than its previous size would account for. With this updating, the current state and history of a model object approximately matches the current state and history of the corresponding deployed object. However, this updating depends for its correctness on the matching of observed behavior to the correct object in the application model.

By way of analogy, one may view there is a connection between each model object and some observed behavior in the input data, similar to the TCP networking protocol. That is, a prediction/expected behavior is a transmission that expects an ack back from the input that acks the prediction. However, for the purposes being disclosed, the transmission is more descriptive of the receiver and the “ack”, if present, is more nuanced, indicating how accurate the transmission is. Moreover, given the observed behavior is available to the model object processing, the “ack” is computed and pulled from the “receiver” state rather than being sent to the receiver for it to respond, as with a network connection. As with the network analogy, the quality of the connection, that is confidence in the connection, depends in part on whether the input data is available or not.

In one embodiment, a metric in observed behavior may in part correspond to a change in a base metric over time intervals. For instance, rather than only using the actual number of bytes received, the observed behavior may include a value corresponding to the change in the number of bytes received over a time interval. This first derivative information may be used to create additional distance between an observed behavior and an expected behavior when they are not the best match. For example, this delta information may be abstracted to simply indicating an increasing value or a decreasing value. Then, for instance, if the expected behavior indicates decreasing and the observed behavior is increasing, this first derivative information creates additional distance between the two, reducing the likelihood of an incorrect matching. Even with an on-off value or non-incrementing, the number of transitions that occur may be checked for being consistent with those expected. Using this first derivation information reduces the need to synchronize between deployed elements and the corresponding model object or objects.

In one embodiment, the comparable first derivative values is computed for the expected behavior. This is because this first derivative information is computed by extrapolating the first derivative values from the previous history of the corresponding object. And, this is possible because this previous history may be derived from the observed behavior from earlier time periods.

In one embodiment, there are multiple behavioral histories, computed or received from different sources, that correspond to the same object. For instance, a database server may report information on its clients while each client may report information/observations on the database server it is using. Consequently, in this scenario there are two sources of observations on a database server. Similarly, with an autonomous robot, it may have radar, camera and LIDAR and possibly other inputs that it is using to track objects in its proximity. These different inputs may provide separate observed behavior that may be associated with the same or different objects.

Expected Behavior. There is also what is referred to herein as expected behavior of an object; the behavior expected of the object based on its current and past state as well as knowledge of the application domain, including the behavior of other objects that are related to this object. For example, if the prior transmit and receive counts were in a particular range in the past and fairly stable, approximately the same values may be expected in the latest time interval. The term behavior is used herein because the general case is matching the state of an object over time, not just its current state.

In one embodiment, because the model object is updated by previously observed behavior, the expected behavior is indirectly dependent on previously observed behavior of the object, indirect through the model object state, as illustrated earlier in FIG. 3. The correctness of this model state is dependent on the correct matching between the observed behavior and the corresponding model object.

In one embodiment, the expected behavior is governed by various laws of the domain. For example, with a collection of robots, the position of another robot may be predicted by physics, namely kinematics based on its speed over the last time interval as well as its physical capabilities to change its acceleration during that time. Therefore, by the laws of physics in this case, the expected behavior may be inaccurate but may not be completely wrong.

In one embodiment, there are multiple expected behaviors possible for a given object in the monitored system in the same timestep, which may correspond to different types of objects it can be in a relation with or different modes it can be in. Thus, the matching may match one of these expected behaviors, thereby determining which mode the real element is in or should be tracked as, but also achieving a match even if a usual or previous expected behavior would not. This is illustrated in FIG. 5, wherein there are two possible expected behaviors (512), (514) for object O1 (502).

As a specific case, there may be an alternate expected behavior corresponding to “unrelated”, that is if the object is not related by the specified relationship. For example, if a leafswitch is no longer connected to any core switch, it may be viewed as connected to the “null” core switch, so its expected behavior is no packets received and no input signal on its uplinks. Using different expected behaviors allows for a logically discontinuous change in behavior by the associated object, for example from connected to disconnected.

In one embodiment, the expected behavior of an object is also indicated in part as the expected behavior of one or more of its components. For example, the behavior of a leaf switch is indicated as the expected behavior of one or more of its interfaces. Similarly, the expected behavior of a moving obstacle is indicated in part by the expected behavior of its nearest surface. After all, that nearest surface may be all that is visible/observable to the monitoring system.

In one embodiment, the expected behavior is modified based on what aspects are known to be occluded/not observable by the monitoring mechanisms. That is, the expected behavior does not expect to have observed behavior include that which is occluded. One example is the above one, in which only the nearest surface of an obstacle is visible to a robot, the rest being occluded by the rest of the obstacle. Therefore, the expected behavior is refined to this nearest surface before being matched to observed behavior. Similarly, with a computer network, if the monitoring of a given switch is known to be missing for a specific period of time, it is effectively occluded by that failure, and this also is reflected in the expected behavior.

Distance and Correlation. The term correlation is defined herein as a statistic measure between two data variables. As disclosed herein, there may be, and normally are, multiple metrics in characterizing the behavior of an object, and not just a single one.

In one embodiment, the comparison between observed and expected behavior is computed as a distance between the two, that is a numeric value in which a lower value means a logically closer correlation. This is illustrated in FIG. 5 with k distance metrics distance 1 through distance k, corresponding to two expected behaviors “a” and “b”.

In one embodiment, this distance computation is a complex calculation that takes application domain considerations into account. For example, the observed behavior of a leaf switch in a data center may be too far away in physical distance to be connected to a particular core switch, independent of other matching characteristics. In this vein, the distance calculation may hypothesize that there is a new object appearing at the same time as another object appears to have gone away, when it is not sensible for this new object behavior to be associated with an existing object, such as one that has changed. For example, if a leaf switch is removed at the same time as a new leaf switch is added in another part of the data center, applications considerations may dictate that this is not the same leaf switch but in fact a new leaf switch. These application considerations may be reflected by having the computed distance for a given pairing be a very large value, thereby excluding this pairing.

In one embodiment, the distance computation is specific to the aspects of the observed behavior. For example, the observed behavior that is matched to the expected behavior may be transformed significantly from the form of the actual input data, depending on the specific type of input. Similarly, the expected behavior may be transformed depending on this specific distance computation. For example, a robot camera may provide as actual input a pixel image of a scene. It is transformed into an observed range and observed edges. Similarly, the expected behavior may be provided as expecting the object in front to move to a closer position, but this expected behavior is then transformed for the distance computation into a determination of expected range of the observable surface of this object and its expected surfaces and/or edges. Therefore, the actual distance is computed on like metrics or quantities, and different for different observed behavior.

In one embodiment, the distance is computed, at least in part, by a ruleset-based computation where each rule whose condition matches the inputs provides a contribution to the value of the distance. For example, if the types of objects are known, a rule may indicate that if the type of the object corresponding to the observed behavior differs from that of the type of the expected object, the distance is made very high. The use of rules in the distance calculation allows the calculation to have singularities or discontinuities. It also allows complex conditions in the computation of the distance. For example, the rule on non-matching types above may be extended to factor in the confidence that the monitoring system has in the type of the observed object and/or the expected object. Low confidence in either may cause a rule consequence that imposes a higher distance value than if there is high confidence in both.

In one embodiment, the distance measure uses the editing cost of transforming the expected behavior to the observed behavior, similar to a traditional Levenshtein distance computation.

In one embodiment, the distance computation has access, that is a back pointer, to the model object associated with the expected behavior and context provided by this model object within the object model. Therefore, it may use additional information based on the specifics of the distance computation with the given observed behavior.

In one embodiment, the distance computation has access, that is a back pointer, to the input source for the observed behavior. Therefore, it may use additional information from this input source based on the specifics of the distance computation and the other information it is working from.

In one embodiment, there is an inverse distance computation that is determining the distance from the expected behavior to the observed behavior that is different from the distance from the same observed behavior to the expected behavior. For instance, the inverse distance may be a large value for expected behavior relative to any observed behavior that is inconsistent with the type or characteristics of the expected object type, even though the observed behavior is close numerically to the expected behavior otherwise. This is analogous to, in a college admissions analogy used later, that a college/expected behavior may rank a student/observed behavior differently than how a student ranks a college. As another case, an observed behavior may be given a large inverse distance with an expected object if the object has already accepted other observed behaviors that it prefers that are incompatible with the new observed behavior. In this example, the inverse distance calculation is not just dependent on the expected behavior per se, but also on the observed behaviors that the expected object has accepted at this point.

As shown in FIG. 5, entity resolution is determined in part by correlation between the expected behavior and the observed behavior. Returning to the network example, object O1 (502) has an expected behavior, and there are observed behaviors by different leaf switches (522), (524), . . . (526). It is thus determined which of those observed behaviors (522), (524), . . . (526) matches to the expected behavior of O1 better. Rather than statically determining a best match, matches are ranked on a distance measure, illuminating how far expected behavior is from observed behavior. For example, if the expectation is a switch loading at 60% and there are three switches observed loaded to 80%, 63% and 40%, a distance measure may determine that the 63% load switch is the closest to the expectation. In one embodiment, more than one measure is used beyond load, for example the number of packets sent and/or the number of packets received. In one embodiment, two different expected behaviors are matched to, for example in the case that a leaf switch is turned on there may be an expected behavior significantly different from an expected behavior in the case that the leaf switch is turned off or disabled. In combination, these multiple matchings may resolve the most likely candidate for a given entity comparing multiple expected behavior to observed behavior.

For example, for FIG. 5 using the network example, a plurality of interfaces may have different expectations (512), (514) where: a first interface has an expectation of 14 sent packets and 12 received packets, in part because an associated switch had sent 12 packets and received 14 packets; a second interface likewise has an expectation of 176 sent packets and 109 received packets; and a third interface likewise has an expectation of 195 sent packets and 109 received packets. For a switch with 64 different interfaces, each interface may have different packet count expectations and also may then have different observed behavior as well.

For example, for FIG. 5 using a self-driving car example, the self-driving system observes a first car in a specified location at a current timestep going a given speed, and observes a second car in a left-hand side location at the current timestep going a different speed. This feeds an expectation of where the first car and second car will be located and what speed they will be going at a subsequent timestep. Incorrect matches may occur, but it is highly unlikely to maintain an incorrect match across multiple timesteps. For example, continuing the self-driving car example, two red cars going a similar speed merge into a “blind spot” which is a lane in front of another vehicle that blocks all observation from the self-driving system. When the two red cars emerge from behind the blocking vehicle, and if they behave similarly, the system may mix the two up. For example, the first red car is driven by an aggressive driver, and the second red car is driven by a slow driver prior to the blind spot. When the two red cars emerge and the aggressive driver suddenly becomes a slower less aggressive driver, and the slow driver starts getting aggressive, a behavioral based system will swap the identities of the two red cars to track their respective new behaviors, rather than attempt to match based on historical behavior. In one embodiment, this behavior is captured within a distance computation, for example a multidimensional distance computation using multiple metrics, for example a Euclidean in three-dimensional space where metric one is a color, metric two is a velocity, and metric three is the amount of visible exhaust coming out of the car.

FIG. 6 is a diagram illustrating an example of computing the distance/logical correlation between the expected and the observed behavior based on metrics in the two behaviors. In one embodiment, correlation across multiple metrics may be computed as a distance based on correlation between metrics. As shown in FIG. 6, the distance may be computed (612), at least in part, as a weighted sum of the values computed from the correlation coefficients, one for each metric between the expected (602) and the observed (604) variable for each attribute defined in the behavior. Note that the distance may instead be computed as the Euclidean distance. However, because the distance is only used for comparison and has no independent semantic meaning, the extra overhead of squaring the metric differences and taking the square root does not change the result and may simply incur unnecessary overhead.

In one embodiment, the weights indicate the importance of the differences for each metric or attribute. For example, it is expected that there is a difference between the expected receive packet count and the observed receive packet count. Therefore, the contribution of this distance is scaled down by the associated weight. In one embodiment, the correlation between the expected and observed behavior for a given metric is computed by any one of the standard statistical measures. For example, the Pearson or Spearman correlation coefficient calculations may be used.

In one embodiment, a correlation coefficient is normally in the range between −1 to +1 for a given pairing of metrics, with 1 indicating the strongest correlation. In one embodiment, to transform a correlation coefficient into a distance where a smaller value is better, the distance for a metric is computed as:

di=Wi−cc*Wi

where cc is the correlation coefficient and Wi is the weight for that metric. Thus, a perfect positive correlation has a correlation coefficient value of 1, so the distance is 0. Lower values of the cc result in greater distance.

In one embodiment, the weight used in the distance calculation is adjusted based on prior history of the computed distance for this metric. That is, a link that is detected experiencing higher loss may use a smaller weight than low-loss links for this metric, so it is less sensitive to the difference in receive count than otherwise. Other calculations of the distance between expected and observed may be used without limitation.

Deferred Acceptance and Deferred Rejection. Assignment mechanisms are used in computing such as deferred assignment mechanisms like the Stable Marriage problem in a simple one-to-one match environment. In one embodiment, the observed and expected behaviors of objects are matched using what is referred to herein as a deferred acceptance method such as a variant of the Gale-Shapley College Admission Algorithm (CAA) and/or hospital residency problem. An example of the “college admissions problem” is the 2018-2019 admissions year for the United States, wherein approximately 3.68 million high school graduates sought a matching with 2.90 million college enrollment slots, wherein each high school graduate applied to one or more colleges with a personal rank choice, and each college had an institutional selection criteria for a high school graduate. For example, drawing the parallel to this college admissions problem, the observed behaviors or objects associated with each are treated as the students, and the expected object is treated as the college. That is, a given object in the model may have multiple observed behaviors associated with it, similar to a college with multiple accepted students, whereas an observed behavior may not be associated with multiple expected objects, similar to the fact that a student cannot be admitted to or associated with multiple colleges. Finally, the distance computation provides a ranking between each pair of observed behavior and expected behavior.

Continuing the example, the ranking of expected behavior to observed behavior—that is, a college's ranking of a student—or the inverse distance, may be incorporated as well. That is, each expected object may have certain preferences and constraints depending on its characteristics. For example, a 1 Gbps interface may only be matched with an observed transmit or receive byte count that is equivalent to less than 1 Gbps. Thus, the inverse distance may be high even if the distance from observed to expected is low. Also, a model object may not accept multiple observed behaviors of the same type or category, especially if their differences are not explainable and may even be contradictory.

In contrast to CAA, the deployed system is dynamic, that is the set of students, the set of colleges and their rankings of students and colleges are changing over time and thus there is iterative re-matching of students to colleges and the matching may be changing over time. Note that this is different from traditional techniques described as “iterative deferred acceptance.” Continuing the computer network monitoring example, the number of the switches, number of links/interfaces and which links connect which pairs of interfaces may change over time.

In one embodiment, matching is refined periodically, either in response to changes or after a period of time. At the start of a period, there is a match between observed behaviors from the last period and the expected behavior. There may also be observed behavior that is causing new tentative objects to be introduced. There may also be observed behavior that is not received because of some failure or an element going inactive.

In one embodiment, the accepted observed behaviors for an expected object may depend on the totality of observed behavior tentatively associated with/accepted by an expected behavior, in contrast to the conventional college admission problem. As discussed herein, it is an improvement to allow an observed behavior OBi that has been tentatively accepted by an expected object EOj to be rejected after all observed behavior has been received by EOj. This is referred to herein as deferred rejection because the rejection may be deferred until all the observed behavior for that expected object has been received. To illustrate with the robot scenario, the expected behavior of the surface is 6 meters away. However, one sensor may report a surface as being 5 meters away, the next two sensors/observed behaviors accepted might report it as 7 meters away. Then, an additional and final 2 sensors may report it as being 5 meters away. Then, on an indication that there are no more observed behaviors matching to this expected object, the processing may conclude to adjust the model position for the surface to be 5 meters away and then reject the observed behaviors of the two sensors reporting 7 meters so they are then unmatched. Consequently, a rematching is performed to handle these now-unmatched observed behaviors. If the initial observed behavior OBi had been rejected to be unmatched after the two 7 meter observed behaviors had been received, the resulting matching would not have been correct. This latter behavior is referred to herein as the premature rejection problem.

As an analogy to describe deferred acceptance and deferred rejection, imagine the hospital residency problem with a hospital taking in up to a quota of ten resident doctors and indicating they will specialize in a field depending on the majority of residents' specialty. The first two acceptable candidates are in psychiatry, and the subsequent eight acceptable candidates are in surgery. With deferred acceptance, the quote of 10 residents has been filled, but two are in psychiatry and eight are in surgery, so the specialization is stuck as blended between two specialties. With deferred rejection, at the prepare-to-commit phase the two psychiatry residents are rejected so that only eight surgery residents are taken, forming a specialty in surgery. Put another way, the prepare-to-commit phase permits the system to have seen all candidates and decide whether to accept all matches or reject some of the matches.

Matching of Observed to Expected Behavior. FIGS. 7A and 7B are a flow diagram illustrating an embodiment of a process for matching of observed behavior to expected behavior. In one embodiment, the process of FIGS. 7A and 7B is processed by the system of FIG. 1. For example, FIGS. 7A and 7B illustrate a flow diagram of deferred rejection.

In one embodiment, the matching of observed to expected behavior is updated periodically at least in part by steps to:
1. Provide the expected behaviors (“EB”) of existing model objects in step (702);
2. Receive and/or compute the observed behaviors (“OB”) in step (704);
3. While there are unmatched OB in step (706), that is, in the event there are unmatched OB:
   a. Select the next unmatched OB in step (710);
   b. Attempt to tentatively assign via EB to another object as described below in steps (712), (714), (722), (724), (728), (730), and (732); and
   c. if unmatched, this OB is added to rejected list in step (726), and subsequently control is transferred back to step (710) for a new unmatched OB;
4. And when the OB to be processed is null in step (712), do a prepare-to-commit processing on the matching of each expected object in step (714);
5. If there are additional unmatched OB then work through the unmatched observed behaviors using the above loop starting in step (706);
6. When there are no longer any additional unmatched OB in step (706), then commit the matching of each expected object in step (708); and
7. output the matching at stopping.

Attempting to tentatively assign via EB to another object includes a step (712) to determine whether a given OB is a null: if yes, control is transferred to the prepare-to-commit processing step (714) as described above; otherwise control is transferred to step (722) wherein the next EB is retrieved for the given OB. In the event that this next EB is null in step (724): control is transferred to the “add to rejected list” step (726) as described above; otherwise control is transferred to step (728) with an attempt to assign the given OB and this next EB. In the event the assign is accepted in step (730): control is transferred to step (732) to indicate the given OB is matched to this next EB, and subsequently control is transferred back to step (710) for a new unmatched OB; otherwise, control is transferred to the next step (722) for a new EB.

In one embodiment, the expected behavior for the current period is based in part on the inter-object relationships from the previous period. In one embodiment, the matching or assigning of an unmatched observed behavior is to an expected behavior/object that ranks higher and/or closer in distance than any to which it has not been previously matched to in this processing. This may be accomplished by rank ordering the expected behaviors relative to their distance from the given observed behavior, that is minimum distance first. The attempt to assign may fail for a given expected behavior. In this case, the matching attempts to assign to the next expected behavior, if any. Otherwise, this observed behavior may be recorded as rejected.

In one embodiment, the commit processing (708) is performed by performing commit processing on each expected object/behavior. Similarly, the prepare-to-commit processing (714) may be performed by performing prepare-to-commit processing on each expected object/behavior. The prepare-to-commit processing (714) may cause an expected behavior/object to reject an observed behavior that it previously accepted, causing it to become unmatched again. In this case, a rematching is performed on unmatched observed behaviors, as indicated in FIGS. 7A and 7B.

Robot Grasping Object Example of Prepare-to-Commit. In a matching mechanism between expected behaviors and observed behaviors, it may be an improvement to see all observed behaviors that are potentially matched with the expected behavior before deciding which observed behaviors would be kept and/or discarded. The phase of prepare-to-commit is a form of transactional notion which declares that all matchings have been done but require an additional phase to reassess whether each of the matchings are satisfied with each other.

In a robot grasping object example, consider a robot arm as an anchored object and/or element of focus, that at last timestep observed a graspable object seven feet to the left of the arm, forming an expected behavior. The robot arm has at least five sensors to detect objects around the arm. The first sensor indicates an object that is five feet to the left. The second sensor also indicates an object that is five feet to the left. A reasonable hypothesis is that based on the two sensors, the graspable object is now five feet to the left of the arm. Then, the third sensor indicates an object that is seven feet to the left. The fourth sensor indicates an object that is seven feet to the left. The fifth sensor indicates an object that is seven feet to the left. If all the sensor readings to this point are accepted, then the first and second sensors accepted are not consistent with the third, fourth, and fifth sensors accepted. At this prepare-to-commit stage then, the first and second sensors are rejected.

This unmatching after all unmatched observed behaviors have been processed may be required to avoid the premature rejection problem described above. As another motivating example, a core switch may need to tentatively accept more leaf switches than is consistent with its uplink bandwidth if later received observed behavior may eliminate one or more of the leaf switches from being accepted. Otherwise, it may prematurely reject a candidate leaf switch based on this uplink constraint whereas this leaf switch would otherwise be accepted once the other leaf switches were rejected/properly rejected. On the other hand, if it does accept more leaf switches than is consistent with its uplink bandwidth and none of them are rejected before prepare-to-commit (714), it may need to enforce this leaf switch-wide constraint at the prepare-to-commit step (714).

That is, to avoid premature rejection, the core switch may resolve this conflict only after being informed that there are no more observed behaviors that are to tentatively match this core switch. Therefore, the deferred rejection method includes the prepare-to-commit (714) phase, unlike traditional techniques. Similarly, if two or more expected behaviors of the same object are matched and these two expected behaviors are incompatible, the observed behaviors accepted by all but one of these expected behaviors may be rejected, and thus become unmatched, in favor of a selected expected behavior. In all these cases, one or more observed behaviors may become unmatched as a result of prepare-to-commit processing, thereby requiring a repeat of the basic matching method.

Once there are no unmatched observed behaviors as a result of prepare-to-commit processing, the deferred acceptances may be committed. The acceptance of the matching is referred to herein as a two-phase acceptance with iteration. That is on prepare-to-commit, the first phase, each expected object determines the observed behaviors that it is going to accept, rejecting any others. If no expected object rejects any of its tentatively accepted observed behaviors, the match across all of the expected objects is committed in the second phase.

This method recognizes that the problem is to achieve the “least bad” matching of observed behaviors to expected behaviors, not to find ideal matches pair-wise because that ideal matching may not exist. That is, an observed behavior is not expected to match precisely with an expected behavior. Instead, it produces a matching that may not be improved by changing the pairings between observed and expected behaviors.

In one embodiment, the number of times the rematching is performed after observed behaviors become unmatched is bounded by an application restriction such as a threshold.

In one embodiment, the tentative acceptance of an observed behavior may trigger the immediate rejection of a previously tentatively accepted observed behavior, rather than waiting for prepare-to-commit (714). This refinement means that a tentative acceptance may be revoked earlier so that the then unmatched observed behavior may be reconsidered sooner.

This method differs from traditional techniques on deferred acceptance in that:
1. the final acceptance is two-phase and the first phase, prepare-to-commit, may cause rematching;
2. the matching is performed periodically rather than once. This is because the inter-relationships in the deployed system may be changing over time. Thus, there is less concern that the match is strictly stable because the basis of the matching is evolving from one period to the next. There may be an initial matching at each round based on the previous round; and/or
3. there may be new objects introduced by additional observed behavior, whereas with traditional techniques, such as with the college acceptance problem, the set of students and colleges are fixed.

In the normal case, when there are two or more different expected behaviors of an object at the same time, these expected behaviors are so different that having observed behavior match both is unlikely. For example, if one expected behavior is a switch is enabled on and connected, and the other is that it is disabled, and thus not connected, there should be relatively little commonality in observed behavior between these two cases. In this example, for instance, any observed behavior that indicates it must be enabled would disqualify/remove the disabled expected behavior from consideration for this object.

In some applications, there is an initial object model and relationships specified. Then, the initial round uses these pre-specified inter-object relationships. Otherwise, the above method is extended with an initialization to handle the starting point:
1. Each object with its expected behavior EB is tentatively matched with its closest observed behavior(s) that have not already been matched to by another object;
2. Each observed behavior OB tentatively accepts the tentative match from their most preferred object (expected behavior) among the tentative matches it has received so far; and
3. Perform the above per-round match processing.

In one embodiment, if the new comparative distance is less than a configured threshold for a given current expected and observed behavior pair, the comparisons to other possible pairings is skipped. This optimization is feasible in many applications for which a key application characteristic is that, if this current matching is incorrect yet the matchings are within this threshold distance, the distance is highly likely to increase, causing a rematching effort to take place at a later time, and further, that temporary mispairing is acceptable. Other suitable matching algorithms may be used without limitation.

Matching and State Updating. In one embodiment, the commit processing (708) updates the application model to make it consistent with the accepted observed behavior associated with each expected object.

In some applications, the association of the input data and thus observed behavior to a particular object is known and possibly fixed. Then, the state of this object may be updated directly from the inputs. In this case, the teachings of the disclosed may only apply to separately determining the inter-object relationships.

However, in some applications, there may be no clear association between some input data and model objects. For example, a robot tracking other robots using RADAR receives input that indicates surfaces but does not provide any direct indication of which other robot to associate with the surface. In these applications, the matching of this input data to objects provided herein is performed before applying, and in order to apply, the input data to adjusting the state of the right object. Continuing this example, the radar surface is matched to another robot and then the position of this surface is used to update the position of the robot to which it is matched.

Restricted Matching. In one embodiment, attributes or characteristics between the expected object and the observed behaviors may restrict the matching that is required, rather than performing matching between all pairs. For example, if the expected object is a leaf switch which necessarily only has 24 ports, it only has to be compared against observed behaviors that report on 24 ports. That is, there is no need to consider other types of observed objects in determining the pairing. Similarly, if the expected object is a database server, the matching is restricted to just those observed behaviors that correspond to a database.

This restricted matching reduces the overhead versus matching all pairs of observed and expected behaviors. If the restricted search fails, the matching may be expanded to a larger set of the objects, and/or potentially all objects.

In one embodiment, the characteristics may be referred to herein as the type of an object and this is referred to herein as type-based restrictive matching. In one embodiment, this restricted matching is implemented by performing what is referred to herein as a pre-match on these specific attributes or characteristics/type. If the pre-match fails between an observed behavior and expected behavior, the full distance computation on this pair is not performed. In one embodiment, the distance computation terminates as soon as the distance value is determined to be over some large threshold value. For example, a type mismatch may directly determine that the distance effectively exceeds this threshold.

In one embodiment, there are one or more subcollections per type of observed behaviors/objects. Therefore, during the matching, the observed behaviors of the collection of observed behaviors of type T are matched against an expected objects of type T. For instance, there may be a separate collector mechanism for collecting the observed behavior of databases from other elements because, for instance, the format of the observed behavior may be unique to database servers. Thus, the collection of database observed behaviors is already separate from other observed behaviors. Thus, an expected object that is a database server only has its expected behavior compared against the observed behaviors in this database-specific collection.

In one embodiment, the types of the objects in the model is identified first. The type may be explicitly indicated or may be inferred by the metrics being provided for an object. To illustrate the latter, an object in a network with a large number of interfaces is most likely a switch, not a host. This typing may either be static as a fixed assigned type or may be so-called “duck” typing, where its type is assigned based on its behavior and this type may even be changed based on changing behavior. In some applications, the observed behavior for some objects includes an explicit identification of the object.

In one embodiment, if two observed behaviors contain the same explicit identification of the object, these two observed behaviors may be treated as a single combined observed behavior for the purposes of matching. For example, if there are two reports received that describe a switch interface with the same MAC address, assuming the MAC addresses are unique, these are treated as observed behaviors of the same object.

If the same explicit identification is present in the expected behavior, an object's expected behavior is only compared to the observed behavior with the corresponding identification. Then, if the distance is excessive, the system reports an indication of this condition. That is, if the expected to observed is explicitly paired, it either leads to high correlation, or correspondingly low distance, or else indicates a problem.

In one embodiment, where this identification is not completely reliable, the identification is used in part to form an initial matching but is still subject to rematching. For example, in a network, it is possible for a host to report the wrong IP address in its observed behavior, causing a mismatch, which is then overridden by other aspects of the observed behavior. This situation may be reported to the operator as a potential mis-identification, like a configuration error in this example.

Note that it may be possible that the method resolves an entity incorrectly. For instance, if two switch interfaces in a network behavior exactly or very closely the same, it is possible to end up with them being paired one with the other and thus incorrectly. However, if their behavior is truly the same for the model, the incorrect pairing does not matter because it has no effect on the model. That said, it is unlikely over time for these two “identical twins” to behave sufficiently the same to persist this confusion. Moreover, in the target application domain in which the deployed system is changing without sufficient notice, it is invariably the case that the object model is incorrect for some period of time until corrected. Therefore, the application may need to accommodate the fact that the model may be incorrect for some period of time, but that incorrectness is resolved in a timely way. That is, the incorrectness does not persist except when it does not matter, referred to herein as the identical twin situation.

Robot Grasping Object Example for Flow Diagram. Returning to the robot grasping object example for FIGS. 7A and 7B, at start in step (702) an EB, EB1, is provided as “graspable object seven feet to the left of the arm”. The OB are received in step (704), including OB1 and OB2 both as “graspable object five feet to the left of the arm” and OB3, OB4, and OB5, as “graspable object seven feet to the left of the arm”. At step (706), there is an unmatched OB, so control is transferred to step (710).

At step (710) the next unmatched OB is the first OB, OB1. OB1 is not null at step (712), so the next EB for OB1 is EB1 at step (722), and EB1 is not null at step (724), so there is an attempt to assign OB1 to EB1 at step (728). Given the correlation between “graspable object five feet to the left of the arm” of OB1 and “graspable object seven feet to the left of the arm” of EB1, for example the distance is considered reasonably close, the assign is accepted in step (730) and OB1 is indicated as matched to EB1 in step (732).

At step (710) the next unmatched OB is the second OB, OB2. OB2 is not null at step (712), so the next EB for OB2 is EB1 at step (722), and EB1 is not null at step (724), so there is an attempt to assign OB2 to EB1 at step (728). Given the correlation between “graspable object five feet to the left of the arm” of OB2 and “graspable object seven feet to the left of the arm” of EB1, for example the distance is again considered reasonably close, the assign is accepted in step (730) and OB2 is indicated as matched to EB1 in step (732).

At step (710) the next unmatched OB is the second OB, OB3. OB3 is not null at step (712), so the next EB for OB3 is EB1 at step (722), and EB1 is not null at step (724), so there is an attempt to assign OB3 to EB1 at step (728). Given the correlation between “graspable object seven feet to the left of the arm” of OB3 and “graspable object seven feet to the left of the arm” of EB1, for example the distance is considered close or identical, the assign is accepted in step (730) and OB3 is indicated as matched to EB1 in step (732).

At step (710) the next unmatched OB is the second OB, OB4. OB4 is not null at step (712), so the next EB for OB4 is EB1 at step (722), and EB1 is not null at step (724), so there is an attempt to assign OB4 to EB1 at step (728). Given the correlation between “graspable object seven feet to the left of the arm” of OB4 and “graspable object seven feet to the left of the arm” of EB1, for example the distance is again considered close or identical, the assign is accepted in step (730) and OB4 is indicated as matched to EB1 in step (732).

At step (710) the next unmatched OB is the second OB, OB5. OB5 is not null at step (712), so the next EB for OB5 is EB1 at step (722), and EB1 is not null at step (724), so there is an attempt to assign OB5 to EB1 at step (728). Given the correlation between “graspable object seven feet to the left of the arm” of OB5 and “graspable object seven feet to the left of the arm” of EB1, for example the distance is again considered close or identical, the assign is accepted in step (730) and OB5 is indicated as matched to EB1 in step (732).

At step (710) there are no more unmatched OB, so the next unmatched OB is “null”, such that at step (712) control is transferred to step (714) for the prepare-to-commit phase. At prepare-to-commit the inconsistency between OB1/OB2 and OB3/OB4/OB5 is detected and so OB3/OB4/OB5 are considered matched and OB1/OB2 are considered back to the unmatched status. Control is then transferred back to the step (706) checking for unmatched OB, which is “yes” as there are now two unmatched OB, so control is transferred to step (710).

At step (710) the next unmatched OB is the first OB, OB1. OB1 is not null at step (712), so control is transferred to step (722). Another EB is sought in step (722), but in this example there are no more EB so the EB is “null” in step (722) and OB1 is added to the rejected list in step (726).

At step (710) the next unmatched OB is the first OB, OB2. OB2 is not null at step (712), so control is transferred to step (722). Another EB is sought in step (722), but in this example there are no more EB so the EB is “null” in step (722) and OB2 is added to the rejected list in step (726).

At step (710) there are no more unmatched OB, so the next unmatched OB is “null”, such that at step (712) control is transferred to step (714) for the prepare-to-commit phase. At prepare-to-commit there are no remaining inconsistencies with OB3/OB4/OB5. Control is then transferred back to the step (706) checking for unmatched OB, which is “no” as the OB1/OB2 are in the rejected list. In step (708) the commit stage commits OB3/OB4/OB5 as matching EB1, and the matching mechanism stops.

Inter-object Cause-effect Inferred Expected Behavior. In one embodiment, information on the cause-effect relationships between objects is used to generate the expected behavior for an object. FIG. 8 is a diagram illustrating an example of predicting expected behavior based on cause-effect rules. In one embodiment, the behavior of the causing object is directly or indirectly observable or predictable at least in part, and/or cause-effect rules are used in part in determining expected behavior. For example, in an airplane, if the throttle is observed as increased and the engine is operating normally, the expected behavior is that the thrust from the engine is increased. Therefore, if the throttle is increased at one time interval, the expected behavior is increased thrust from the engine in the next time interval.

In one embodiment, an inter-object cause-effect rule means that a cause observed in one object may be used to predict in part the expected behavior in the other object, as shown in FIG. 8 with cause object co (802) and effect object eo (804). For example, if O1 is a switch interface, as the anchor object, and the condition is the transmitCount, if there is a switch interface O2 at the other end of the same link, there is a cause-effect rule that is or may be inferred as a packet transmission in O1 causing the transmitCount to be incremented then causing the O2 receiveCount to increment, with high probability. More specifically, the transmitCount being incremented N times infers that N packets were transmitted, which then implies that N packets should be received at O2, which implies that the receiveCount at O2 is incremented N times. Similarly, the link-up/link-down periods observed at O1 implies similar up/down periods being observed at O2. Therefore, if this “connected” relation holds between O1 and O2, the observed behavior of O1 implies an expected behavior in O2. Therefore, if the connected relation holds, the inferred expected behavior in O2 may be strongly correlated on this metric or effect to the observed cause behavior in O1.

Cause-effect inferred expected behavior may provide more accurate expected behavior then may be expected between the expected behavior and observed behavior of objects that are not in the associated relationship or relationships. That is, non-correlation implies greater distance so there is less a likelihood to be paired. Illustrating with the previous example, if the receive count in O2 is not correlated with that predicted based on this cause-effect rule, it is less likely that this connected relationship holds. Here, the qualifier “less likely” is used to indicate that it is possible that the “connected” relation holds yet the correlation is weak, for example a large number of packets may be dropped and thus not received because they are corrupted if the link is noisy. In some cases, the discrepancy may be handled by depending on a receive corrupted packet count as well. That is the O2 receiveCount and receiveCorruptedCount should be roughly equal to, that is correlated to, transmitCount in O1.

In general, if a cause ca and context cont on O1 causes the effect efi on O2 by relationship R when O1 is connected to O2 by relationship R, this may be specified as a cause-effect inter-object rule:
if O1:ca and O1::cont->R->O2::efi

Therefore, if the cause O1:ca is observed and context O1::cont at O1 and the effect O2::efi is not observed at O2, the relationship R between O1 and O2 is less likely to be true. Put another way in FIG. 8, for cause object co (802) and effect object eo (804) the relationship (806):
co::causei && co::contj && R::eo->eo::effectk
   for cause causei of co, context contj of co, and effect effectk of eo holds.

Also, the more accurate expected behavior that is determined in part from cause-context-effect ruleset should more strongly correlate with observed behavior when the observed behavior is associated with the correct expected object.

The expected behavior may be inferred indirectly by a sequence of cause-effect rules. For example, a burst of packets arriving on an up/down link may infer a load on the leaf switch which may infer a packet load on one or more of the servers. Thus, at least some of the servers that are candidates to be connected to this leaf switch are expected to have received some load.

Conversely, an object cannot cause an effect on another object unless there is some relationship between the two objects. If that relationship is not represented in the model, the model is incomplete on that aspect. That said, an object may exhibit the behavior predicted by a cause just coincidentally even without being in the target relationship. Therefore, incorrect matching is possible; it is just unlikely and even less likely to persist over some period of time, and if it does, as with the “identical twin” situation, it does not make the model significantly incorrect in many cases.

As another example, if a new client C1 appears to a database server and application processes only use one database at a time, if another known client C2 is no longer reported as a client for another database, it may be feasible to infer that client C1 is actually C2. That is, the previously observed behavior may be unmatched to C2 and then free to be rematched to C1.

Using Inverse Rules. FIG. 9 is a diagram illustrating an example of predicting expected behavior based on inverse rules to cause-effect rules. In one embodiment, the expected behavior may be predicted at least in part based on inverse rules to cause-effect rules wherein the behavior of the effected object is directly or indirectly observable or predictable. Put another way, what is observed corresponds to an effect rather than the cause. In one embodiment, inverse rules to cause-context-effect rules are provided. For example, in a switched network, an inverse rule may be:
if O2: receiveCount is incremented by RPI and O1 is an interface connected to O2 then O1: transmitCount has been increased by at least RPI.

Thus, if O2 is the anchor object and if this received count increase is observed, then the expected behavior previously is that O1 had its transmit count increased by at least this amount, from which one may further infer that at least RPI packets were transmitted.

Using the same logic as with inter-object cause-effect inferred expected behavior, these inverse rules may be used to generate a more accurate characterization of the expected behavior of an object based on the observed behavior of this other anchor object. Therefore, leveraging these rules may make it more likely that the matching algorithm is going to match correctly, that is perform the entity resolution correctly, and thus determine the inter-object relationships properly.

In one embodiment, the inverse ruleset is provided in part by inverting a ruleset of cause-effect rules as described in U.S. patent application Ser. No. 18/215,146 entitled AUTOMATIC SENSOR TO ACTUATOR MAPPING GENERATION filed Jun. 27, 2023 which is incorporated herein by reference for all purposes.

In one embodiment, an inverse rule may be used to infer an expected behavior in another object where the other object is not observable, yet the expected behavior is used to infer additional expected behavior in yet other objects that may be observed. For example, the loss of signal in two connected interfaces may be used to infer the expected “behavior” that there is a break in the connecting cable. A broken cable may be inferred to cause certain higher-level connections to fail-over to certain alterative paths. Therefore, if the connections going over this link are known, this inference may be used to help identify the connections that they failed over to, that is the ones that failed over in the time window of this cable break. In a sense, the cable is the anchor object, given this is inferring the connections that were traversing this cable. The inverted ruleset may infer a cable break as the probable root cause of the system fail-over without this event being directly observable which may then be used to infer expected behavior of other objects. This is another example of indirect inference of expected behavior.

More formally, the inverse with input as efi and result being ca is then: O2:efi && (E: in-inverse-R-to-O2): cond-> (E: in-inverse-R-to-O2): ca

This is shown in FIG. 9 for effect object eo (902) with effect effectk, cause object co (904) with context contj and cause causei, and inverse rule inverseR, with the relationship
eo::effectk && co::contj && inverse::eo->co::causei

A key aspect here is that the expected and observed behavior may be collected over multiple timesteps, so even though there is a time skew between a cause and effect, the distance-based correlation may still be used to pair the observed metrics with the right object. A complication of matching an observed behavior with the expected behavior is the potential time skew between events.

Handling Time Skew. There may be a time skew between expected behavior and observed behavior that may compromise the accuracy of the matching. For instance, in the simple cause-effect case, a cause occurs at time Ti at the anchor object O1 whereas the effect is only observed at time Tj, for some later time Tj. Therefore, the expected behavior in the effected object is really only expected at time Tj. More indirect inference of expected behavior may further increase the time skew. Conversely, using an inverse rule as part of determining the expected behavior, the expected behavior as the cause necessarily occurred earlier in time than the observed behavior on which it is inferred.

In one embodiment, the expected behavior is extrapolated forward in time to more closely match the time of the observed behavior, assuming the expected behavior corresponds to an earlier time. For example, if a network has long delay links, the matching may infer that packets transmitted at time Ti are only going to affect the receive counters at the other end at time Tj. Therefore, the incremental effect of this inference is only applied for matching to observed behavior marked as being collected at or after time Tj. As another example, the expected position of a robot may be extrapolated forward in time based on a previous position and the velocity and acceleration observed with this robot from an earlier time.

In one embodiment, one or more metrics used in computing the matching of observed to expected behavior are computed across, that is using, a multi-timestep window. To illustrate using the earlier example, rather than using the actual observed receive count as the metric for the correlation, the computed metric of a weighted moving average of the receive count is used. That is, the expected value of the weighted moving average of the receive packet count computed from the observed transmit count over several timesteps is compared to the weighted moving average of the observed receive packet count as part of computing the distance between the expected and the observed behavior. This means that the distance calculation is less effected by the time skew between the transmission of packets and their reception.

It also means that a sudden change in behavior from what is expected does not immediately invalidate the matching. For instance, if a cable break occurs so no packets are received out of those transmitted, the “connected” relation is not immediately invalidated. Instead, if the monitoring station is performing root cause identification, it may detect the potential cable break before the system concludes that this relationship has changed.

In one embodiment, the multi-timestep window and weights (if using a weighted moving average) are adjusted based on the expected timeskew between the one object with the cause and the object showing the effect. There is a trade-off between weighing the past in the computed metric relative to the present. In particular, if the past is weighed heavily, it takes longer to recognize that a relationship has changed.

In one embodiment, the weighting of the past in the computed metric is increased if the raw metric is quite volatile or the time for a relationship to change is relatively long. For example, moving a cable from one switch to another is a manual process and therefore may take seconds or longer and is a raw event. Therefore, the past may be weighted quite heavily. On the other hand, a client application process may switch from using one database server to using another in under a second. Therefore, the weighing of the past should be less. As illustrated earlier, in some applications, the likelihood of a connection or relationship having a fault may be much higher than the relationship actually changing. Therefore, it may be an improvement to weight the past so that the fault is detected before there is an attempt to redetermine the relationship. In that vein, detecting a fault in a relationship may be an input to the cause-context-effect rule to avoid redetermining unnecessarily. Also, the monitoring system may avoid both indicating the fault and indicating it may not determine the object in this relationship.

In one embodiment, the system is prepared for an object “failing over” to using a different object or different connection in response to the fault. This may show up by there being an object that is in this relationship with this different object that correlates with the original object.

In one embodiment, the frequency of a relationship changing may be monitored over time and used to automatically adjust this weighting. In one embodiment, the rematching of expected to observe behavior is accomplished in part by playing and/or replaying the observed behaviors of the past while correcting the time skew. For instance, if an expected behavior is known to have occurred at time Ti in the past by an inverse rule based on observed behavior at a later time Tj, which is now also in the past, this expected behavior may be incorporated into a timeline when the inputs or behaviors are replayed at previous time to Ti.

Entity Resolution using Deferred Rejection. FIG. 10 is a diagram illustrating an example of entity resolution by an inter-object relationship or linking. In some applications, new tentative model objects are instantiated corresponding to observed behavior that turn out to correspond to some existing and/or pre-existing object. That is, the new tentative model object may be created that turns out to correspond to, or be the same as, an existing model object, typically when the deployed object behaves quite differently than expected. For example, a robot tracking the position of an obstacle moving to the left may be confused if this obstacle suddenly reverses direction and moves to the right. Because the observed behavior is quite different from the expected behavior, the observed behavior may be associated with a new tentative model object. Note that it is a possible scenario that the first obstacle disappeared, and this other observed behavior is actually a different obstacle.

In one embodiment, tentative new model objects are created, and the deferred rejection method is used to identify tentative model objects that correspond to an existing model object. In particular, the method may be performed with the relationship being “the same”, that is object O1 is in the relationship “the same” as referred to herein with object O2 if O1 and O2 correspond to the same deployed object. Thus, the distance between two objects is small if, by comparing comparable attributes, the differences are small. The observed object behavior is that of the tentative model object and the expected objects are the existing objects. As in traditional entity resolution, two objects that are deemed to be “the same” may be linked by that relationship rather than immediately strictly merged into a single model object, as illustrated in FIG. 10 where two clients client a (1002), and client b (1004) for a database server A (1006) are linked as being the same process. Merging into a single model object may be handled as an optimization when it is clear that the two objects are truly the same.

FIG. 11 is a diagram illustrating an example of entity resolution by relationship to a master object. In one embodiment, a master expected behavior is generated in part by hypothesizing a relationship between two model objects O1 and O2. Then, these two objects are matched against this master expected behavior. This is illustrated in FIG. 11 where the master object is client 14 (1102), and the hypothesis is that client a (1104) and client b (1106) for database server a (1108) both correspond to this same client 14 (1102).

By basing the entity resolution on relationships, the whole notion of entity resolution may be extended and generalized. For instance, a database client may be viewed as a role that a process is playing. Moreover, a process may play multiple roles in a system. Therefore, the model may actually need to determine if the same process is playing two different observed roles, not if these two observed roles are “the same.” As other examples, the resolution required may be whether two observed behaviors correspond to the same host, or arise from physical components in the same physical rack or pod, or correspond to the same user. Thus, there are many different notions of “the same” that can be handed, depending on the application.

FIG. 12 is a flow diagram illustrating an embodiment of a process for using correlation between observed versus expected behavior for object model relationship tracking. In one embodiment, the process of FIG. 12 is carried out by the system of FIG. 1.

In step (1202), a model is accessed comprising objects and EB of objects. In one embodiment, the provided model comprises a plurality of objects and expected behaviors of the plurality of objects. In one embodiment, an expected behavior indicates a relationship between objects. In one embodiment, the expected behavior is determined in part using cause-effect rules. In one embodiment, the expected behavior is determined in part using the inverse ruleset from cause-effect rules.

In one embodiment, in a step not shown in FIG. 12 pre-matching is used to reduce the number of comparisons to observed behaviors. For example, a robot may pre-match sensor inputs (of observed behavior) on its left side to an object known previously to be on its left side. In one embodiment, in a step not shown in FIG. 12 pre-classification by type of objects is used to reduce the number of comparisons to observed behaviors. Continuing the earlier example, a robot may pre-classify input sensor observed behavior based on whether indicating a tall obstacle versus a short obstacle, and use this information to pre-match when, for instance, there is a short obstacle and a tall obstacle on the left, thereby using the pre-classification to disambiguate an initial pre-matching. In one embodiment, in a step not shown in FIG. 12 rematching is performed in part by replaying behaviors from the past in the proper time sequence.

In step (1204), OB of one or more objects are received via one or more sensors. In one embodiment, observed behaviors of one or more objects in the model are received, the observed behaviors being obtained by the sensor configured to collect observed behaviors. In one embodiment, a sensor is physical or virtual.

In step (1206), one or more relationships are determined between objects via matching OB and EB. In one embodiment, relationships are determined between at least two of the objects in the model, at least in part by use of a matching mechanism based at least on one or more observed behaviors and one or more expected behaviors.

In one embodiment, the matching is performed using deferred acceptance. In one embodiment, matching is performed using a modified version of the Gale-Shapley algorithm, for example for the college-student assignment problem.

In one embodiment, the matching is performed using deferred rejection. In one embodiment, the matching is performed using two-phase acceptance. In one embodiment, matching comprises a ranking determined in part by a distance computed between an observed object behavior and an expected behavior. In one embodiment, the distance is computed in part based on the correlation between metrics in the observed and expected behavior. In one embodiment, the distance is computed in part using a ruleset-based computation.

In one embodiment, the matching is performed multiple times with potentially changing behavior of objects. For example, if a robot is matching sensory input indicating observed behavior to objects that are moving non-deterministically, the matching is repeated periodically to ensure the object model is correctly tracking this object movement. In one embodiment, the matching is approximate. For example, the transmit count on a network switch interface may not exactly match the receive count on the interface connect to this first interface, because of lost packets or the timing skew between transmit and receive. Instead, this criterion is considered to match if the counts are approximately the same, i.e. the different between the two counts is less than some threshold value.

In step (1208), the one or more relationships are output to an actuator. In one embodiment, the relationships are output to the actuator configured to take suitable application action. In one embodiment, an actuator is physical or virtual. An actuator as referred to herein includes a device that causes a physical device to (further) act, display, and/or operate. An actuator may be physical such as a steering wheel or virtual such as a computing variable associated with a counter like a medical order. Examples of an actuator include without limitation: machine controls, aileron control, elevator control, stabilator control, rudder control, wing flaps control, leading edge devices, spoiler control, trim systems, autopilot toggle, ejection seat activator, accelerator, brake control, steering control, parking brake control, lights toggle, communications control, robot arms, LED display, database store, magnetic/optical storage, electromagnetic wave, stock purchase order, and/or a medical diagnosis record. Suitable application action as referred to herein includes actions such as turning a steering wheel, adjusting an accelerator, controlling a brake control, adjusting a medical order, exerting aileron/elevator/stabilator/rudder control, activating an ejection seat, toggling lights, moving a robot arm, asserting communications control to flag a networks issue, adjusting a stock purchase order, and updating a record in a database.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a sensor;
an actuator;
a processor coupled to the sensor and the actuator and configured to:
access a model comprising a plurality of objects and expected behaviors of the plurality of objects;
receive observed behaviors of one or more objects in the model, the observed behaviors being obtained by the sensor configured to collect the observed behaviors;
determine one or more relationships between at least two of the objects in the model, including to use a matching mechanism based at least on one or more observed behaviors and one or more expected behaviors;
output the one or more relationships to the actuator configured to take suitable application action; and
a memory coupled to the processor and configured to provide the processor with instructions.

2. The system of claim 1, wherein the sensor is physical or virtual.

3. The system of claim 1, wherein an expected behavior indicates a relationship between at least two of the plurality of objects.

4. The method of claim 1, wherein the matching is performed using deferred acceptance.

5. The method of claim 4, wherein the matching is performed using a modified version of the Gale-Shapley algorithm.

6. The method of claim 1, wherein the matching is performed using deferred rejection.

7. The method of claim 6, wherein the matching is performed using two-phase acceptance.

8. The method of claim 6, wherein the matching comprises a ranking determined in part by a distance computed between an observed object behavior and an expected behavior.

9. The method of claim 8, wherein the distance is computed in part based on the correlation between metrics in the observed and expected behavior.

10. The method of claim 8, wherein the distance is computed in part using a ruleset-based computation.

11. The method of claim 1, wherein the matching is performed multiple times with potentially changing behavior of objects.

12. The method of claim 1, wherein the matching is approximate.

13. The method of claim 1, wherein expected behavior is determined at least in part using cause-effect rules.

14. The method of claim 1, wherein expected behavior is determined at least in part using the inverse ruleset from cause-effect rules.

15. The method of claim 1, wherein the processor is further configured to use pre-matching to reduce the number of comparisons to observed behaviors.

16. The method of claim 1, wherein the processor is further configured to use pre-classification by type of objects to reduce the number of comparisons to observed behaviors.

17. The method of claim 1, wherein the processor is further configured to perform rematching at least in part by replaying behaviors from the past in the proper time sequence.

18. The system of claim 1, wherein the actuator is physical or virtual.

19. A method, comprising:
providing a model comprising a plurality of objects and expected behaviors of the plurality of objects;
receiving observed behaviors of one or more objects in the model, the observed behaviors being obtained by a sensor configured to collect observed behaviors;
determining relationships between at least two of the objects in the model, at least in part by use of a matching mechanism based at least on one or more observed behaviors and one or more expected behaviors; and
outputting the relationships to an actuator configured to take suitable application action.

20. A computer program product embodied in a non-transitory computer readable medium and comprising computer instructions for:
providing a model comprising a plurality of objects and expected behaviors of the plurality of objects;
receiving observed behaviors of one or more objects in the model, the observed behaviors being obtained by a sensor configured to collect observed behaviors;
determining relationships between at least two of the objects in the model, at least in part by use of a matching mechanism based at least on one or more observed behaviors and one or more expected behaviors; and
outputting the relationships to an actuator configured to take suitable application action.
